(19) United States
(12) Patent Application Publication
(10) Pub. No.: US 2015/0002417 A1
(43) Pub. Date: Jan. 1, 2015

(54) METHOD OF PROCESSING USER INPUT AND APPARATUS USING THE SAME

(71) Applicant: Samsung Electronics Co., Ltd., Suwon-si (KR)

(72) Inventors: Jong-Wu BAEK, Gumi-si (KR); Yeun-Wook LIM, Daegu (KR)

(73) Assignee: Samsung Electronics Co., Ltd., Suwon-si (KR)

(21) Appl. No.: 14/290,235

(22) Filed: May 29, 2014

(30) Foreign Application Priority Data
Jun. 26, 2013 (KR) 10-2013-0073861

(51) Int. Cl. G06F 3/041

(52) U.S. Cl. CPC G06F 3/0416
USPC 345/173

(57) ABSTRACT

A method of processing a user input is provided. The method includes sensing whether a touch input event occurs on the touch screen, identifying an input movement pattern of a portable electronic apparatus detected by a motion sensor included in the portable electronic apparatus, and determining whether a touch input matched to the touch input event is valid, in view of the identified input movement pattern.

### CROSS-REFERENCE TO RELATED APPLICATION(S)

This application claims the benefit under 35 U.S.C. §119(a) of a Korean patent application filed on Jun. 26, 2013 in the Korean Intellectual Property Office and assigned Serial No. 10-2013-0073861, the entire disclosure of which is hereby incorporated by reference.

### TECHNICAL FIELD

The present disclosure relates to a technology for processing a user input in a portable electronic apparatus. More particularly, the present disclosure relates to a technology for processing a user input received through a touch screen.

### BACKGROUND

As portable electronic apparatuses (or handheld devices) including touch screens have recently come into wide use, there is a growing interest in technologies related to touch screens.

Research and development are being conducted on various schemes for driving a touch screen, such as a resistive type touch screen, a capacitive type touch screen, an optical type touch screen, an ultrasonic wave type touch screen, a resonance type touch screen, and the like. Together with the development of the schemes for driving a touch screen, a multi-touch processing technology capable of detecting a touch input event, which occurs on the touch screen in multiple areas, is being developed.

Also, various touch input interfaces each using a touch input that a user inputs can be installed in the portable electronic apparatus including the touch screen. Particularly, in the portable electronic apparatus including the touch screen, a Graphic User Interface (GUI), such as an icon, a soft key and the like, is displayed on the touch screen, and a corresponding touch input is processed.

### SUMMARY

Further, the portable electronic apparatus may detect not only a touch input in an area in which the user generates a touch input, but also a touch input in another area, for example, an area touched by the user's finger or palm with which the user grasps the portable electronic apparatus. Accordingly, the portable electronic apparatus may not process a touch input in an area desired by the user, but may process a touch input in an unintentionally-touched area. Otherwise, the portable electronic apparatus may process the touch inputs as multiple touch inputs. As a result, problems may occur in that it is impossible to accurately process the touch input in the area desired by the user.

Therefore, there is a need for a method and an apparatus capable of more accurately determining a touch input from a user and increasing the stability of the user input, and removing a touch input that a user does not intend to generate and accurately processing a user input.

The above information is presented as background information only to assist with an understanding of the present disclosure. No determination has been made, and no assertion is made, as to whether any of the above might be applicable as prior art with regard to the present disclosure.

Aspects of the present disclosure are to address at least the above-mentioned problems and/or disadvantages and to provide at least the advantages described below. Accordingly, an aspect of the present disclosure is to provide a method and an apparatus capable of more accurately determining a touch input from a user and increasing the stability of the user input.

Another aspect of the present disclosure is to provide a method and an apparatus capable of removing a touch input that a user does not intend to generate and accurately processing a user input.

In accordance with an aspect of the present disclosure, a method of processing a user input is provided. The method includes sensing whether a touch input event occurs on the touch screen, identifying an input movement pattern of a portable electronic apparatus detected by a motion sensor included in the portable electronic apparatus, and determining whether a touch input matched to the touch input event is valid, in view of the identified input movement pattern.

In accordance with another aspect of the present disclosure, a portable electronic apparatus is provided. The portable electronic apparatus includes a touch screen configured to display information and to detect a touch input event which a user inputs, a motion sensor configured to detects a motion of the portable electronic apparatus, at least one controller, and a memory unit configured to store at least one program and stored movement patterns respectively matched to multiple soft keys included in a soft keypad, wherein the at least one program is configured to be executed by the controller, and comprises: an instruction that identifies a soft key matched to the touch input event, an instruction that recognizes an input movement pattern detected by the motion sensor, and an instruction that determines whether the soft key matched to the touch input event is valid, by comparing the detected input movement pattern and each of the stored movement patterns.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a portable electronic apparatus, to which a method of processing a user input is applied according to an embodiment of the present disclosure;

FIG. 2 is a perspective view of a portable electronic apparatus, to which a method of processing a user input is applied according to an embodiment of the present disclosure;

FIG. 3 is a flowchart illustrating a method of processing a user input according to an embodiment of the present disclosure;

FIG. 4 is a view illustrating an example of a detected movement pattern detected by a method of processing a user input according to an embodiment of the present disclosure;

FIG. 5A is a view illustrating an example of a soft keypad used in a method of processing a user input according to an embodiment of the present disclosure;

FIG. 5B is a view illustrating an example of stored movement patterns used in a method of processing a user input according to an embodiment of the present disclosure;

FIG. 6 is a flowchart illustrating sub-operations of operation 330 illustrated in FIG. 3 according to an embodiment of the present disclosure; and

FIGS. 7A and 7B are perspective views of a portable electronic apparatus, to which a method of processing a user input according to another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although terminology including ordinals, such as “first” and “second,” may be used in describing various configurational elements, the configurational elements are not limited by such terminology, which is used merely to differentiate one configurational element from another. For example, a first configurational element may be referred to as a second configurational element and vice versa without departing from the scope of the present disclosure. Any such terminology used herein is not intended to limit the present disclosure but to aid in the description of specific embodiments. As another example, a term expressed in the singular includes the plural form as well, unless clearly indicated otherwise in context.

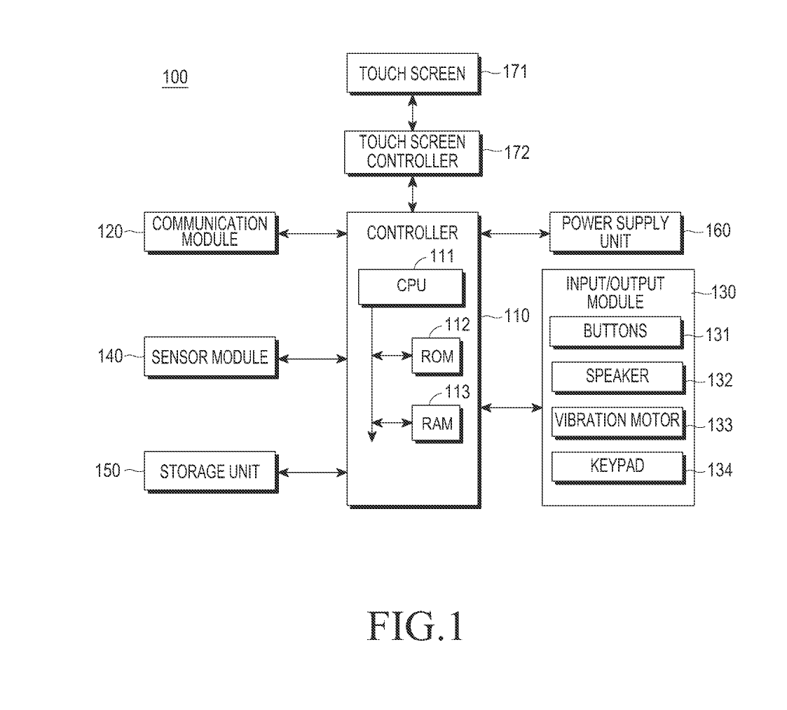

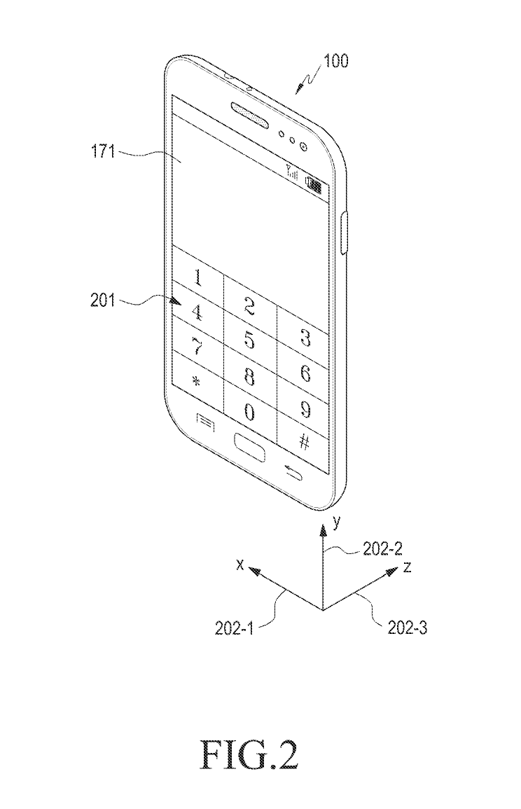

FIG. 1 is a block diagram illustrating a configuration of a portable electronic apparatus, to which a method of processing a user input is applied according to an embodiment of the present disclosure. FIG. 2 is a perspective view of a portable electronic apparatus, to which a method of processing a user input is applied according to an embodiment of the present disclosure.

Referring to FIG. 1, the portable electronic apparatus 100 includes the controller 110, a communication module 120, an Input/Output (I/O) module 130, a sensor module 140, a storage unit 150, an electric power supply unit 160, a touch screen 171 and a touch screen controller 172.

The controller 110 may include a Central Processing Unit (CPU) 111, a Read Only Memory (ROM) 112 storing a control program for controlling the portable electronic apparatus 100, and a Random Access Memory (RAM) 113, which temporarily stores signals or data received from the outside of the portable electronic apparatus 100, or is used as a storage area for the operations performed in the portable electronic apparatus 100. The CPU 111, ROM 112 and RAM 113 may be interconnected via an internal bus. The controller 110 may control the sensor module 140, the storage unit 150, the power supply 160, the touch screen 171, and the touch screen controller 172. The controller 110 may be comprised of a single core, or may be comprised of multiple cores such as dual cores, triple cores, and quad cores. It will be apparent to those of ordinary skill in the art that the number of cores is subject to change depending on the characteristics of the terminal.

The sensor module 140 includes at least one sensor for detecting the state of the portable electronic apparatus 100. For example, the sensor module 140 may include a proximity sensor for detecting a user's access to the portable electronic apparatus 100, an illumination sensor (not shown) for detecting a quantity of light around the portable electronic apparatus 100, a motion sensor (not shown) for detecting motion (for example, rotation of the portable electronic apparatus 100, and acceleration or vibration applied to the portable electronic apparatus 100) of the portable electronic apparatus 100, a geo-magnetic sensor (not shown) for detecting a point of a compass by using earth's magnetic field, a gravity sensor for detecting a direction of gravity, and an altimeter for detecting an altitude by measuring atmospheric pressure. At least one sensor may detect the state, generate a signal corresponding to the detection, and transmit the signal to the controller 110. The sensor of the sensor module 140 may be added or omitted according to the performance of the portable electronic apparatus 100.

The storage unit 150, under control of the controller 110, may store signals or data, which are input/output to correspond to operations of the sensor module 140, and the touch screen 171. The storage unit 150 may store a variety of applications and a control program for control of the portable electronic apparatus 100 or the controller 110.

Particularly, the storage unit 150 stores movement patterns for determining whether a touch input event which has been input on the touch screen 171 is valid, as data required to process a method of processing a user input according to an embodiment of the present disclosure. For example, the storage unit 150 stores a movement pattern which is set for each of multiple soft keys included in a keypad for inputting the input of numbers (or characters). Also, the stored movement patterns are used to determine the validity of the input of a soft key, which is identified based on a touch input event. Further, the controller 110 detects a movement pattern matched to the input of a valid soft key within a portable electronic apparatus, and thereby continues to update the movement patterns which are respectively set for the multiple soft keys, which have been stored in the storage unit 150.

The term ‘storage’ as used herein may include the storage unit 150, the ROM 112 and RAM 113 in the controller 110, and a memory card (not shown) (for example, a Secure Digital (SD) card, a memory stick) mounted in the portable electronic apparatus 100. The storage may include a non-volatile memory, a volatile memory, a Hard Disk Drive (HDD), a Solid State Drive (SSD) and the like.

The power supply 160, under control of the controller 110, may supply the power to one or multiple rechargeable batteries (not shown) mounted in the housing of the portable electronic apparatus 100. The one or multiple batteries (not shown) supply power to the portable electronic apparatus 100. The power supply 160 may supply the power received from the external power source (not shown) to the portable electronic apparatus 100 through a wired cable that is connected to a connector mounted in the portable electronic apparatus 100. The power supply 160 may supply, to the portable electronic apparatus 100, the power that is wirelessly received from the external power source by wireless charging technology.

The touch screen 171 may display User Interfaces (UIs) corresponding to various services (for example, calls, data transmission and the like) for the user, based on the terminal's Operation System (OS). The touch screen 171 may transfer an analog signal corresponding to at least one touch entered on a UI, to the touch screen controller 172. The touch screen 171 may receive at least one touch input through the user's body (for example, fingers including the thumb) and/or a touch input means (for example, a stylus pen). The touch screen 171 may receive a continuous movement input of one among at least one touch. The touch screen 171 may transfer an analog signal corresponding to a continuous movement of an input touch, to the touch screen controller 172.

The touch screen 171 may be implemented using, for example, a resistive type touch screen, a capacitive type touch screen, an infrared type touch screen, or an acoustic wave type touch screen.

The touch screen controller 172 controls output values of the touch screen 171 so that the display data provided from the controller 110 may be displayed on the touch screen 171. The touch screen controller 172 converts analog signals received from the touch screen 171 into digital signals (for example, X/Y coordinates) and transfers them to the controller 110. The controller 110 may control the touch screen 171 using the digital signals received from the touch screen controller 172. For example, in response to a touch event or a hovering event, the controller 110 may select or execute a related shortcut icon (not shown) displayed on the touch screen 171. The touch screen controller 172 may be incorporated into the controller 110.

Particularly, the touch screen 171 displays a soft keypad 201 (see FIG. 2) for inputting characters or numbers, and processes the input of numbers (or characters) in response to a touch input event generated by the soft keypad 201. In other words, the soft keypad 201 displayed on touch screen 171 may include multiple soft keys respectively allocated to predetermined areas, and a number (or a character), which is to be processed in response to a touch input event, may be displayed in such a manner as to be allocated to each of the multiple soft keys. Accordingly, the controller 110 provides data for displaying the soft keypad 201 including the multiple soft keys on the touch screen 171, to the touch screen 171, and the touch screen 171 displays the soft keypad 201 including the multiple soft keys. Also, while displaying the soft keypad 201, the touch screen 171 senses a touch input event, and provides coordinates of a sensed area to the controller 110 through a touch screen controller 172. In response to the provided coordinates of the sensed area, the controller 110 identifies the coordinates of the area in which the touch input event has been sensed, and identifies and processes a number (or a character) allocated to a soft key matched to the relevant area.

Desirably, when processing the number (or the character) matched to the touch input event, the controller 110 determines whether the input of the number (or the character) matched to the touch input event is valid and processes the number (or the character) matched to the touch input event, in a method of processing a user input according to an embodiment of the present disclosure. A specific operation of determining whether the input of the number (or the character) matched to the touch input event is valid, in the method of processing a user input according to an embodiment of the present disclosure, will be described in detail when a method of processing a user input according to an embodiment of the present disclosure is described below. It goes without saying that the method of processing a user input according to an embodiment of the present disclosure as described below can be applied to the portable electronic apparatus.

The communication module 120 may include at least one of a cellular module, a Wireless Local Area Network (WLAN) module, and a short-range communication module.

The cellular module is configured to connect the portable electronic apparatus 100 to the external device by mobile communication via at least one or more antennas (not shown), under control of the controller 110. The cellular module exchanges wireless signals for voice calls, video calls, Short Message Service (SMS) messages and/or Multimedia Messaging Service (MMS) messages, with cellular phones (not shown), smart phones (not shown), tablet Personal Computers (PCs) (not shown) and/or other devices (not shown), whose phone numbers are stored or registered in the portable electronic apparatus 100.

The WLAN module, under control of the controller 110, may be connected to the Internet in the place where a wireless Access Point (AP) (not shown) is installed. The WLAN module supports the 802.11x WLAN standard defined by the Institute of Electrical and Electronics Engineers (IEEE). The WLAN module may drive the Wi-Fi Positioning System (WPS) that identifies location information of the terminal equipment with the WLAN module, using the location information provided by a wireless AP to which the WLAN module is wirelessly connected.

The short-range communication module, a module that wirelessly handles short-rang communication with the portable electronic apparatus 100 under control of the controller 110, may handle communication based on short-range communication such as Bluetooth, Infrared Data Association (IrDA), WiFi-Direct, and Near Field Communication (NFC).

The I/O module 130 may include at least one of buttons 131, a speaker 132, a vibration motor 133, and a keypad 134.

The buttons 131 may be formed on the front, side and/or rear of the housing of the portable electronic apparatus 100, and may include at least one of a power/lock button (not shown), a volume button (not shown), a menu button (not shown), a home button (not shown), a back button (not shown), and a search button (not shown).

The speaker 132, under control of the controller 110, may output the sounds corresponding to various signals (for example, wireless signals, broadcast signals and the like) from the cellular module, the WLAN module and the short-range communication module, to the outside of the portable electronic apparatus 100. One or multiple speakers 132 may be formed in one or multiple proper positions of the housing of the portable electronic apparatus 100.

The vibration motor 133 may convert electrical signals into mechanical vibrations under control of the controller 110. One or multiple vibration motors 133 may be formed in the housing of the portable electronic apparatus 100.

The speaker 132 and the vibration motor 133 may operate depending on the set state of the volume operating mode of the portable electronic apparatus 100. For example, the volume operating mode of the portable electronic apparatus 100 may be operated as a sound mode, a vibration mode, a sound & vibration mode, and a silent mode, and may be set as one of these modes. Based on the set volume operating mode, the controller 110 may output the signal instructing the operation of the speaker 132 or the vibration motor 133 depending on the function performed by the portable electronic apparatus 100. For example, the controller 110 may output a sound signal and a vibration signal to the speaker 132 and the vibration motor 133, respectively, in response to a touch action by the user on the touch screen 171, and/or a continuous movement of a touch on the touch screen 171.

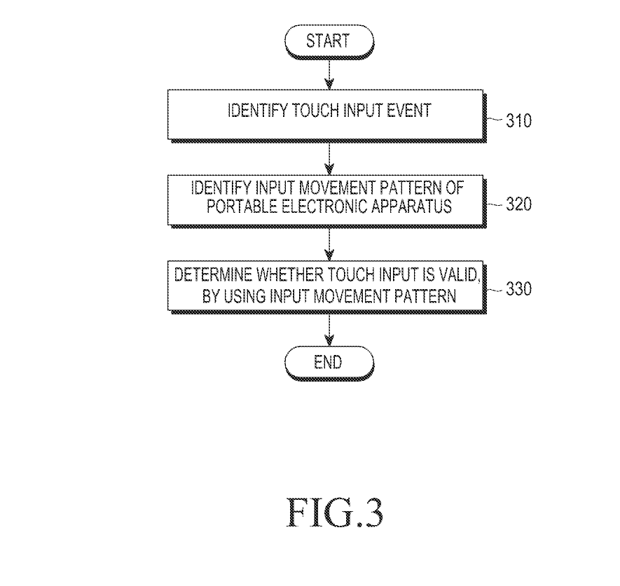

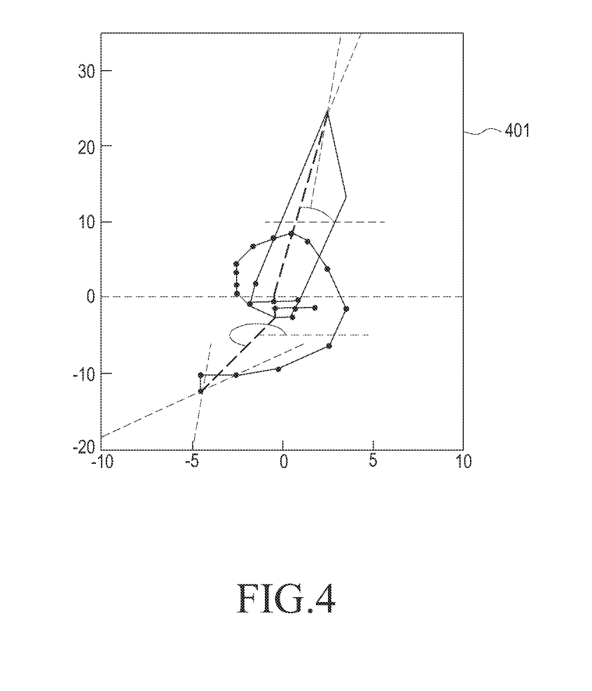

FIG. 3 is a flowchart illustrating a method of processing a user input according to an embodiment of the present disclosure. FIG. 4 is a view illustrating an example of a detected movement pattern detected by a method of processing a user input according to an embodiment of the present disclosure.

The method of processing a user input according to an embodiment of the present disclosure is configured in such a manner that a palm touch can be removed from among user inputs generated on the touch screen 171, in order to determine whether a user input generated on the touch screen 171 is valid. For example, when a keypad for inputting characters or numbers and a soft keypad 201 including multiple soft keys are activated, an operation of the method of processing a user input according to an embodiment of the present disclosure is initiated. For example, the controller 110 starts an operation of the method of processing a user input according to an embodiment of the present disclosure in response to an operation in which a soft keypad capable of receiving multiple numbers (or characters) as input is activated when an operation of a call application is initiated, an operation in which a soft keypad capable of receiving multiple numbers (or characters) as input is activated when an operation of a memo application is initiated, or an operation in which a soft keypad capable of receiving multiple numbers (or characters) as input is activated when an operation of a messaging application is initiated.

Referring to FIG. 3, in operation 310, when a touch input event occurs on the touch screen 171, touch input coordinates that the touch screen 171 and the touch screen controller 172 detect are delivered to the controller 110. In response to the reception of the touch input coordinates, the controller 110 identifies a predetermined key area to which the detected touch input coordinates are matched, and identifies which soft key the predetermined key area corresponds to among the multiple soft keys. Through this operation, the controller 110 identifies a soft key (hereinafter, referred to as an “input soft key”) matched to the touch input event.

In operation 320, the controller 110 combines motion sensor data detected by a motion sensor included in the sensor module 140, and thereby identifies a movement pattern (hereinafter, referred to as an “input movement pattern”) (see 401 of FIG. 4) of the portable electronic apparatus 100. Particularly, when an operation of the method of processing a user input according to an embodiment of the present disclosure is initiated, the controller 110 controls such that an operation of the motion sensor included in the sensor module 140 is activated. Then, the controller 110 identifies a movement pattern depending on a time variation of motion data received from the sensor module 140, as an input movement pattern.

The input movement pattern 401 indicates a change in acceleration and a change in angular velocity in two-dimensional directions (e.g., an X-axis direction 202-1 and a Y-axis direction 202-2 in FIG. 2) of the portable electronic apparatus 100. Specifically, the input movement pattern 401 indicates a time variation of motion data in a range from a predetermined time point before the occurrence of the touch input event to a time point of the occurrence of the touch input event. For example, the input movement pattern includes a time variation of motion data in a range from about 0.5 seconds before the occurrence of the touch input event to a time point of the occurrence of the touch input event.

In an embodiment of the present disclosure, a case is described in which the input movement pattern 401 indicates a change in acceleration and a change in angular velocity in the two-dimensional directions (e.g., the X-axis direction 202-1 and the Y-axis direction 202-2) of the portable electronic apparatus 100. However, the present disclosure is not limited thereto. Accordingly, it goes without saying that the input movement pattern 401 may include a change in acceleration and a change in angular velocity in three-dimensional directions (e.g., the X-axis direction 202-1, the Y-axis direction 202-2 and a Z-axis direction 202-3).

Meanwhile, the storage unit 150 stores a movement pattern (hereinafter, referred to as a “stored movement pattern”) which is set for each of multiple soft keys included in a keypad for inputting numbers (or characters), as data required to process the method of processing a user input according to an embodiment of the present disclosure.

The stored movement pattern may be a movement pattern obtained by standardizing, for each soft key, a time variation of motion data in a range from a predetermined time point before the occurrence of the touch input event to a time point of the occurrence of the touch input event, and storing the standardized time variation of the motion data in the range for each soft key. Also, the stored movement pattern may be a movement pattern configured by repeatedly detecting and storing a touch input event occurring within the portable electronic apparatus 100 and then equalizing the touch input events occurring within the portable electronic apparatus 100. The movement pattern configured by equalizing the touch input events occurring within the portable electronic apparatus 100 may be configured to be updated whenever a touch input is generated by a user. In this regard, the movement pattern is optimized for a user of each portable electronic apparatus 100 by reflecting the movement pattern which may appear to be different for each user. Accordingly, the stability and reliability of a soft key input can be increased.

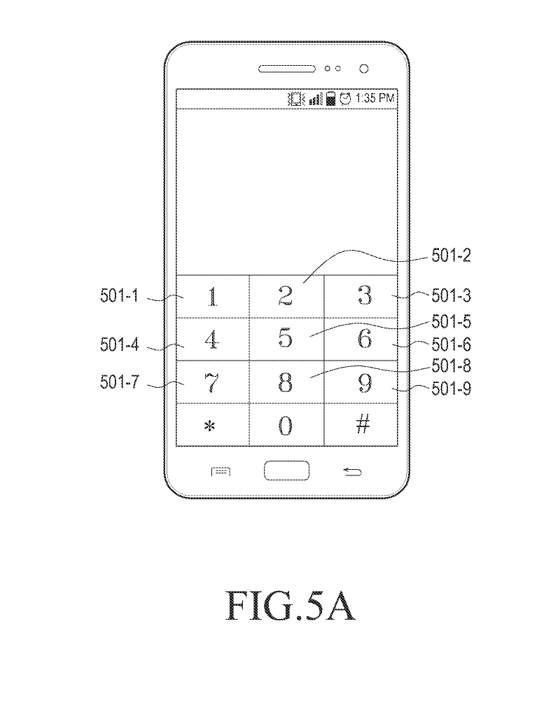

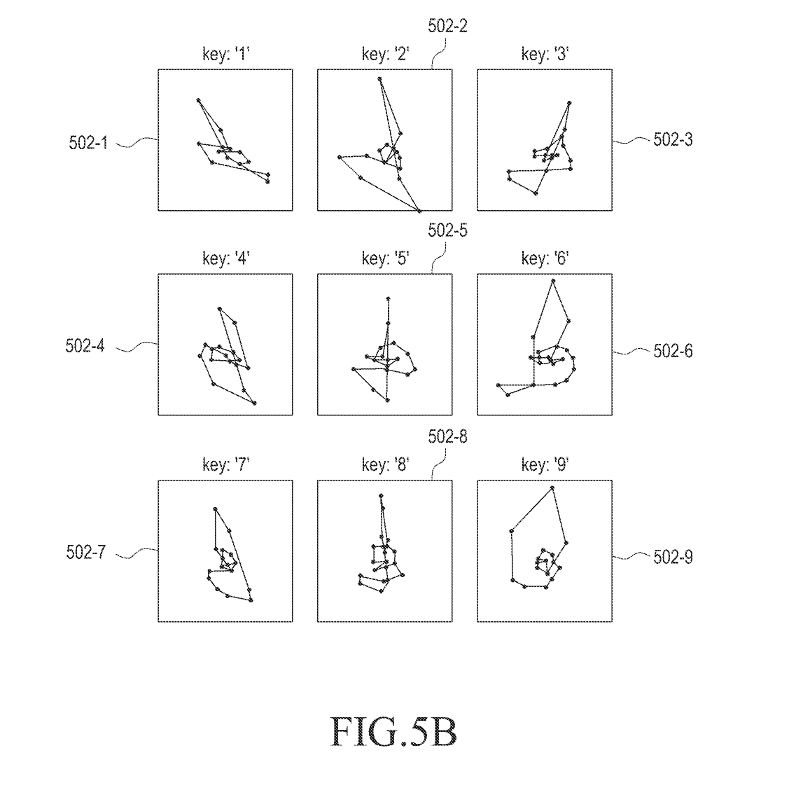

FIG. 5A is a view illustrating an example of multiple soft keys included in a soft keypad according to an embodiment of the present disclosure. FIG. 5B is a view illustrating an example of the stored movement patterns matched to the multiple soft keys according to an embodiment of the present disclosure.

Referring to FIG. 5A and FIG. 5B, a case is described in which a first soft key 501-1 is matched to a first stored movement pattern 502-1, a second soft key 501-2 is matched to a second stored movement pattern 502-2, a third soft key 501-3 is matched to a third stored movement pattern 502-3, a fourth soft key 501-4 is matched to a fourth stored movement pattern 502-4, a fifth soft key 501-5 is matched to a fifth stored movement pattern 502-5, a sixth soft key 501-6 is matched to a sixth stored movement pattern 502-6, a seventh soft key 501-7 is matched to a seventh stored movement pattern 502-7, an eighth soft key 501-8 is matched to an eighth stored movement pattern 502-8, and a ninth soft key 501-9 is matched to a ninth stored movement pattern 502-9.

In operation 330, the controller 110 compares the input movement pattern 401 with each of the stored movement patterns stored in the storage unit 150, and determines whether the input soft key is valid. For example, the controller 110 compares the input movement pattern 401 with the stored movement pattern matched to the soft key identified in the touch input event. Only when the input movement pattern 401 is similar to the stored movement pattern, the controller 110 determines that the input soft key is valid. Specifically, when the input soft key is, for example, the first soft key 501-1, the controller 110 compares the input movement pattern 401 with the first stored movement pattern 502-1. Only when the controller 110 determines that the input movement pattern 401 is similar to the first stored movement pattern 502-1, the controller 110 determines that an input from the first soft key 501-1 is valid. As described above, whether the soft key input is valid is determined by comparing the input movement pattern with each of the stored movement patterns, and the input of numbers (or characters) is processed. Accordingly, the stability and reliability of the soft key input can be increased. As a result, it is possible to reduce an error caused by the input of numbers (or characters) which may be generated by a touch input event that the user does not intend to generate. Also, by reducing the error caused by the input of numbers (or characters) which may be generated by the touch input event that the user does not intend to generate, the user can more quickly input numbers (or characters) which may be generated by a touch input event that the user intends to generate.

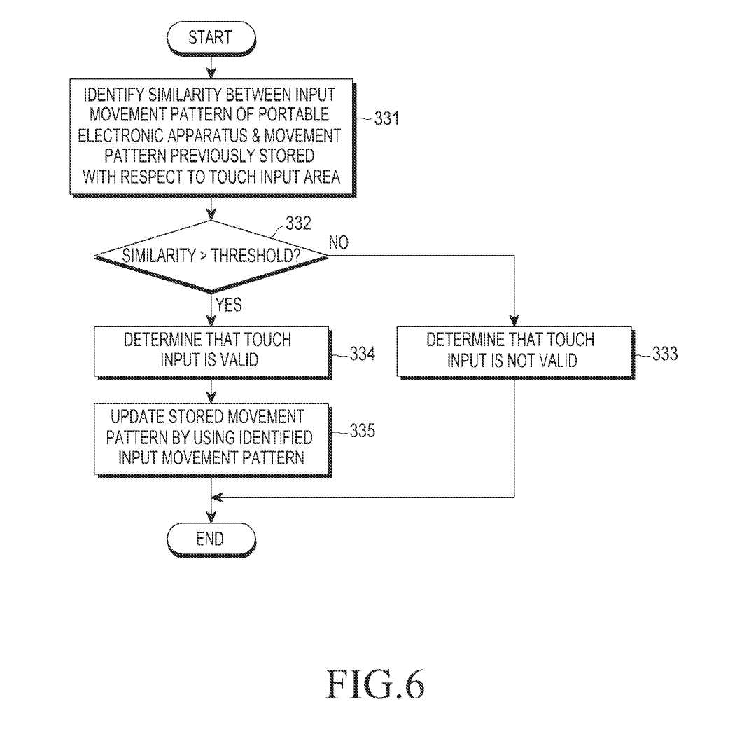

FIG. 6 is a flowchart illustrating sub-operations of operation 330 illustrated in FIG. 3 according to an embodiment of the present disclosure.

Referring to FIG. 6, in operation 331, the controller 110 identifies the input soft key (e.g., the first soft key 501-1) identified in operation 310, and identifies a stored movement pattern (the first stored movement pattern 502-1) matched to the input soft key (e.g., the first soft key 501-1) through the storage unit 150. Then, the controller 110 calculates a similarity between the input movement pattern 401 and the first stored movement pattern 502-1.

In operation 332, the controller 110 determines whether the similarity exceeds a predetermined threshold. When the similarity does not exceed the predetermined threshold, the controller 110 proceeds to operation 333, and determines that the input soft key (e.g., the first soft key 501-1) is not valid. Accordingly, the controller 110 does not output a number (or a character) matched to the input soft key (e.g., the first soft key 501-1), and terminates an operation matched to the relevant touch input event. In contrast, when the similarity exceeds the predetermined threshold, the controller 110 proceeds to operation 334. In operation 334, the controller 110 determines that the input soft key (e.g., the first soft key 501-1) is valid, and processes a number or character (e.g., 1) matched to the input soft key (e.g., the first soft key 501-1), as a user input.

Then, the controller 110 proceeds to operation 335, and updates a stored movement pattern (e.g., the first stored movement pattern 502-1), which is matched to the detected movement pattern, by using the detected movement pattern. For example, the controller 110 updates the first stored movement pattern 502-1 pre-stored in the storage unit 150, by adding the detected movement pattern to the first stored movement pattern 502-1 and calculating an average value for the first stored movement pattern 502-1 and the detected movement pattern.

Hereinabove, a case has been described in which the method of processing a user input according to an embodiment of the present disclosure determines whether a touch input event is valid in a state where the keypad for inputting characters or numbers and the keypad 201 including multiple soft keys are activated. However, the present disclosure is not limited thereto. It is sufficient if the method of processing a user input according to an embodiment of the present disclosure can remove a palm touch among user inputs generated on the touch screen 171.

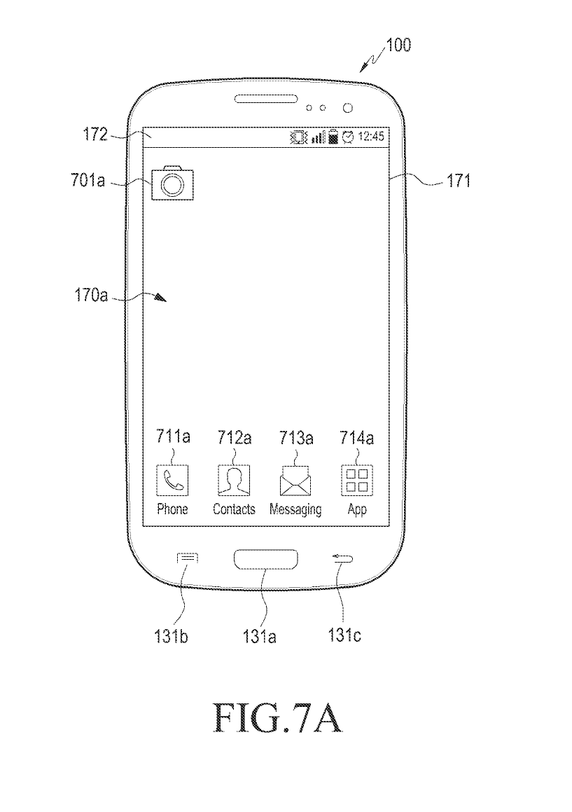

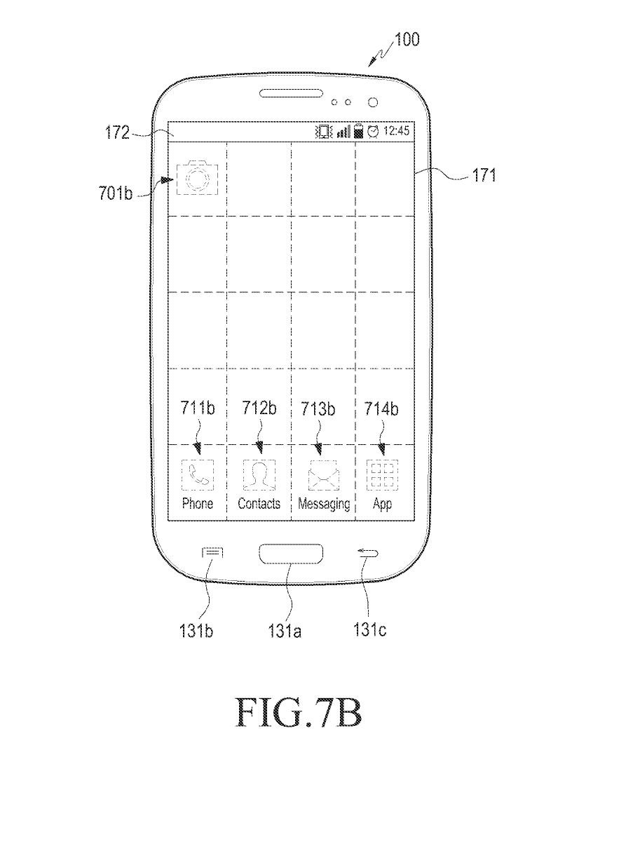

FIG. 7A is a perspective view illustrating an example of a portable electronic apparatus, to which a method of processing a user input according to another embodiment of the present disclosure. FIG. 7B illustrates an example of an area of occurrence of a touch event in a portable electronic apparatus, to which a method of processing a user input according to another embodiment of the present disclosure.

Referring to FIG. 7A and FIG. 7B, the touch screen 171 is disposed at the center of a front surface of the portable electronic apparatus 100. The touch screen 171 is largely formed so as to occupy most of the front surface of the portable electronic apparatus 100. FIG. 7A illustrates an example of displaying a home screen 170a on the touch screen 171. The portable electronic apparatus 100 has different home screens having multiple pages, and a first home screen from among the home screens having multiple pages may be a main home screen. Shortcut icons 711a, 712a and 713a for executing frequently-used applications, a main menu switch key 714a, time, weather, and the like are displayed on the home screen 170a. The main menu switch key 714 is used to display a menu screen on the touch screen 171. Also, a status bar 172 which indicates the status of the portable electronic apparatus 100, such as a battery charging status, the strength of a received signal, current time and a volume operating mode, is disposed at an upper end part of the touch screen 171.

At least one icon 701a for executing an application is disposed on the home screen 170a. To this end, the controller 110 sets areas 701b, 711b, 712b, 713b and 714b, in which the shortcut icons 711a, 712a and 713a, the main menu switch key 714a, the at least one icon 701a, and the like are disposed. Also, the controller 110 receives, as input, coordinates of an area, in which a touch input event has been sensed on the touch screen 171, and executes an application matched to the area in which the touch input event has been sensed.

Also, a home button 131a, a menu button 131b and a back button 131c are disposed at a lower part of the touch screen 171. The home button 131a, the menu button 131b and the back button 131c may be implemented so as to be operated by a touch input, or physical pressing. Basically, the home button 131a displays a main home screen on the touch screen 171. For example, the main home screen is displayed on the touch screen 171 when the home button 131a is touched in a state of displaying a home screen different from the main home screen or the menu screen on the touch screen 171. The menu button 131b provides a connection menu which can be used on the touch screen 171. The connection menu includes a widget addition menu, a menu for changing a background image, a search menu, an edit menu, an environment setup menu, and the like. The back button 131c is used to display a screen displayed just before a currently-displayed screen, or is used to terminate the most recently-used application.

A method of processing a user input according to another embodiment of the present disclosure which is applied to the portable electronic apparatus as described above is configured in such a manner that a palm touch can be removed from among user inputs generated on the touch screen 171, in order to determine whether a user input generated on the touch screen 171 is valid. Accordingly, basically, an operation of the method of processing a user input according to another embodiment of the present disclosure is initiated when a touch input event occurs on the touch screen.

First, when a touch input event occurs on the touch screen 171, touch input coordinates detected by the touch screen 171 and the touch screen controller 172 are delivered to the controller 110. In response to the reception of the detected touch input coordinates, the controller 110 identifies the predetermined key areas 131a, 131b and 131c, or the icon areas 701b, 711b, 712b, 713b and 714b, to each of which the detected touch input coordinates are matched, and identifies applications to which the predetermined key areas 131a, 131b and 131c or the icon areas 701b, 711b, 712b, 713b and 714b are matched, respectively. Through this operation, the controller 110 identifies an input matched to the touch input event.

Next, the controller 110 combines motion sensor data detected by the motion sensor included in the sensor module 140, and thereby identifies a movement pattern (hereinafter, referred to as an “input movement pattern”) (see 401 in FIG. 4) of the portable electronic apparatus 100. Particularly, when an operation of the method of processing a user input according to another embodiment of the present disclosure is initiated, the controller 110 controls such that an operation of the motion sensor included in the sensor module 140 is activated. Then, the controller 110 identifies a movement pattern depending on a time variation of motion data received from the sensor module 140, as an input movement pattern.

The input movement pattern 401 indicates a change in acceleration and a change in angular velocity in two-dimensional directions (e.g., the X-axis direction 202-1 and the Y-axis direction 202-2 in FIG. 2) of the portable electronic apparatus 100. Specifically, the input movement pattern 401 indicates a time variation of motion data in a range from a predetermined time point before the occurrence of the touch input event to a time point of the occurrence of the touch input event. For example, the input movement pattern includes a time variation of motion data in a range from about 0.5 seconds before the occurrence of the touch input event to a time point of the occurrence of the touch input event.

In an embodiment of the present disclosure, a case is described in which the input movement pattern 401 indicates a change in acceleration and a change in angular velocity in the two-dimensional directions (e.g., the X-axis direction 202-1 and the Y-axis direction 202-2) of the portable electronic apparatus 100. However, the present disclosure is not limited thereto. Accordingly, it goes without saying that the input movement pattern 401 may include a change in acceleration and a change in angular velocity in three-dimensional directions (e.g., the X-axis direction 202-1, the Y-axis direction 202-2 and a Z-axis direction 202-3).

Meanwhile, the storage unit 150 stores movement patterns (hereinafter, referred to as “stored movement patterns”) which are set for the predetermined key areas 131a, 131b and 131c or the icon areas 701b, 711b, 712b, 713b and 714b, respectively, as data required to process the method of processing a user input according to another embodiment of the present disclosure.

The stored movement pattern may be a movement pattern obtained by standardizing a time variation of motion data in a range from a predetermined time point before the occurrence of the touch input event to a time point of the occurrence of the touch input event, for each of the predetermined key areas 131a, 131b and 131c or for each of the icon areas 701b, 711b, 712b, 713b and 714b, and storing the standardized time variation of the motion data in the range for each of the predetermined key areas 131a, 131b and 131c or for each of the icon areas 701b, 711b, 712b, 713b and 714b. Also, the stored movement pattern may be a movement pattern configured by repeatedly detecting and storing a touch input event occurring within the portable electronic apparatus 100 and then equalizing the touch input events occurring within the portable electronic apparatus 100. The movement pattern configured by equalizing the touch input events occurring within the portable electronic apparatus 100 may be configured to be updated whenever a touch input is generated by a user. In this regard, the movement pattern is optimized for a user of each portable electronic apparatus 100 by reflecting the movement pattern which may appear to be different for each user. Accordingly, the stability and reliability of a soft key input can be increased.

Next, the controller 110 compares the input movement pattern 401 with each of the stored movement patterns stored in the storage unit 150, and determines whether the touch input event is valid. For example, the controller 110 compares the input movement pattern 401 with a stored movement pattern matched to an area in which the touch input event is sensed. Only when the touch input movement pattern 401 is similar to the stored movement pattern, the controller 110 determines that the touch input event is valid. Specifically, when the user generates a palm touch in the predetermined third key area 131c (or the fourth icon area 714b) while touching the first area 701b, the controller 110 senses a touch input event in the first area 701b, and simultaneously, senses a touch input event in the predetermined third key area 131c (or the fourth icon area 714b). Accordingly, the controller 110 compares a similarity of the input movement pattern 401 with that of a stored movement pattern matched to the first area 701b. Then, in view of a result of the comparison, the controller 110 determines whether a touch input event occurring in the first area 701b is valid. Otherwise, as another example, the controller 110 identifies a first similarity between the input movement pattern 401 and the stored movement pattern matched to the first area 701b, and identifies a second similarity between the input movement pattern 401 and a stored movement pattern matched to the predetermined third key area 131c (or the fourth icon area 714b). Then, the controller 110 determines that a touch input event matched to a larger value from among the first similarity and the second similarity is valid.

Further, in the method of processing a user input according to another embodiment of the present disclosure, a case is described as an example in which an area of the touch screen is divided into the icon areas 701b, 711b, 712b, 713b and 714b as illustrated in FIG. 7B. However, the present disclosure is not limited thereto. It goes without saying that the division of the area of the touch screen can be variously changed by those having ordinary knowledge in the technical field of the present disclosure.

For example, when the user touches the predetermined third key area 131c (or the fourth icon area 714b) with the user's palm without the intention of the user while the user touches a desired point of the touch screen with the user's thumb during a touch input, an error (e.g., a palm touch error) in a user input may occur. Such a palm touch error may occur in a lower left end area (or a lower right end area) of the touch screen 171. Accordingly, a palm touch error can be detected by only sensing the relevant part. To this end, as in the above-described embodiments of the present disclosure, even without dividing the home screen 170a into detailed areas, an error in a user input can be detected by only determining whether a touch input event is valid which has occurred in the lower left end area (or the lower right end area) of the touch screen 171 in which the palm touch error frequently occurs. In view of this configuration, it is sufficient if the home screen 170a is divided to the extent of enabling a determination as to whether a touch input event is valid which has occurred in the lower left end area (or the lower right end area) of the touch screen 171 in which the palm touch error frequently occurs. Also, the number of divided areas of the home screen 170a and the divided areas thereof are variously changed. As described above, whether the touch input event is valid is determined by comparing the input movement pattern with each of the stored movement patterns, and the touch input from the user is processed. Accordingly, the stability and reliability of the touch input can be increased. As a result, by reducing a palm touch input in a touch input event that the user does not intend to generate, the user can more quickly control an operation of the portable electronic apparatus.

The above-described methods according to the present disclosure can be implemented in hardware, firmware or as software or computer code that can be stored in a recording medium such as a Compact Disc (CD) ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an Application Specific Integrated Circuit (ASIC) or Field Programmable Gate Array (FPGA). As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present disclosure have been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of processing a user input by using a touch screen, the method comprising:
sensing whether a touch input event occurs on the touch screen;
identifying an input movement pattern of a portable electronic apparatus detected by a motion sensor included in the portable electronic apparatus; and
determining whether a touch input matched to the touch input event is valid, in view of the identified input movement pattern.

2. The method as claimed in claim 1, wherein the determining of whether the touch input matched to the touch input event is valid comprises:
identifying a similarity between the identified input movement pattern and a previously stored movement pattern matched to the touch input event; and
determining whether the touch input is valid, in view of a result of identifying the similarity.

3. The method as claimed in claim 2, wherein the determining of whether the touch input matched to the touch input event is valid comprises determining that the touch input is not valid, based on the similarity deviating from a range of a predetermined threshold.

4. The method as claimed in claim 2, wherein the determining of whether the touch input is valid, in view of the result of identifying the similarity comprises:
determining whether the touch input event is valid, based on the similarity falling within the range of a predetermined threshold; and
updating the previously stored movement pattern by reflecting the identified input movement pattern in the previously stored movement pattern when the touch input event is valid.

5. The method as claimed in claim 1, further comprising:
activating the motion sensor in response to activation of a touch input key;
storing motion data which is output from the motion sensor during a preset time period; and
detecting the motion data, which has been stored during the preset time period, as the input movement pattern in response to sensing the touch input.

6. The method as claimed in claim 5, wherein the input movement pattern corresponds to a value indicating a time variation of the motion data.

7. The method as claimed in claim 6, wherein the motion data comprises a horizontal movement variation and a vertical movement variation on the touch screen.

8. The method as claimed in claim 7, wherein the motion data further comprises a vertical movement change on a surface of the touch screen.

9. The method as claimed in claim 5, wherein the motion data comprises at least one of an angular velocity value and an acceleration value.

10. A non-transitory computer readable recording medium having recorded thereon a computer program for executing the method of claim 1.

11. A portable electronic apparatus comprising:
a touch screen configured too display information and to detect a touch input event which a user inputs;
a motion sensor configured to detect a motion of the portable electronic apparatus;
at least one controller; and
a memory unit configured to store at least one program and stored movement patterns respectively matched to multiple soft keys included in a soft keypad,
wherein the at least one program is configured to be executed by the controller, and comprises:
an instruction that identifies a soft key matched to the touch input event;
an instruction that recognizes an input movement pattern detected by the motion sensor; and
an instruction that determines whether the soft key matched to the touch input event is valid, by comparing the detected input movement pattern and each of the stored movement patterns.

12. The portable electronic apparatus as claimed in claim 11, wherein the at least one program includes:
an instruction that identifies a similarity between the identified input movement pattern and a previously stored movement pattern matched to the touch input event; and
an instruction that determines whether the touch input is valid, in view of a result of identifying the similarity.

13. The portable electronic apparatus as claimed in claim 12, wherein the at least one program includes an instruction that determines that the touch input is not valid, based on the similarity deviating from a range of a predetermined threshold.

14. The portable electronic apparatus as claimed in claim 12, wherein the at least one program includes:
an instruction that determines whether the touch input event is valid, based on the similarity falling within the range of a predetermined threshold; and
an instruction that updates the previously stored movement pattern by reflecting the identified input movement pattern in the previously stored movement pattern when the touch input event is valid.

15. The portable electronic apparatus as claimed in claim 11, wherein the at least one program includes:
an instruction that activates the motion sensor in response to activation of a touch input key;
an instruction that stores motion data which is output from the motion sensor during a preset time period; and
an instruction that detects the motion data, which has been stored during the preset time period, as the input movement pattern in response to sensing the touch input.

16. The portable electronic apparatus as claimed in claim 15, wherein the input movement pattern corresponds to a value indicating a time variation of the motion data.

17. The portable electronic apparatus as claimed in claim 16, wherein the motion data comprises a horizontal movement variation and a vertical movement variation on the touch screen.

18. The portable electronic apparatus as claimed in claim 17, wherein the motion data further comprises a vertical movement change on a surface of the touch screen.

19. The portable electronic apparatus as claimed in claim 15, wherein the motion data comprises at least one of an angular velocity value and an acceleration value.
